(19) United States
(12) Patent Application Publication
(10) Pub. No.: US 2025/0228259 A2
(43) Pub. Date: Jul. 17, 2025

(54) PLANT-BASED INTRAMUSCULAR FAT SUBSTITUTES

(71) Applicant: Bunge SA, Geneva (CH)

(72) Inventor: Jean Ricardo de Souza, Gaspar (BR)

(21) Appl. No.: 18/546,363

(22) PCT Filed: Feb. 16, 2022
(86) PCT No.: PCT/US2022/016537

§ 371 Date: Aug. 14, 2023

Related U.S. Application Data
(60) Provisional application No. 63/262,262, filed on Oct. 8, 2021.
(60) Provisional application No. 63/149,946, filed on Feb. 16, 2021.

(51) Int. Cl. A23D 7/005; A23D 7/04; A23J 3/14; A23J 3/16; A23J 3/22; A23J 3/34

(52) U.S. Cl. CPC A23D 7/0053; A23D 7/04; A23J 3/14; A23J 3/16; A23J 3/227; A23J 3/346

(57) ABSTRACT

Disclosed are animal fat substitute compositions including an oil-in-water emulsion containing a mixture of one or more plant proteins, and a plant-based oil, and/or a plant-based fat, wherein the emulsion is stabilized with or without an effective amount of transglutaminase. Further disclosed are methods of manufacturing such animal fat substitute compositions.

### CROSS-REFERENCE TO RELATED APPLICATIONS

This application is a U.S. National Stage Entry of International Patent Application No. PCT/US2022/016537, filed on Feb. 16, 2022, which claims priority to U.S. Provisional Patent Application Ser. No. 63/149,946, filed on Feb. 16, 2021, and U.S. Provisional Patent Application Ser. No. 63/262,262, filed on Oct. 8, 2021, the contents of each of which are incorporated by reference in their entirety herein.

### FIELD OF THE DISCLOSURE

The field of the disclosure generally relates to an animal fat substitute composition and a method of manufacturing such composition. More specifically, the field of disclosure relates to an animal fat substitute composition comprising a protein emulsion stabilized with or without the use of transglutaminase.

### BACKGROUND

Animal fat tissue is composed of liquid and solid fats encased within a proteinaceous connective tissue network that has characteristic rheological and physical properties. The microstructure of a meat fat tissue is described in simplistic terms as pools of triglycerides contained within fat cells which in turn are embedded in a strong physical connective tissue matrix. Such structures possess elastic and melting properties that have no parallel in the available vegetable fats and oils environment.

A continuing need exists for plant-based animal connective tissue-like matrix compositions to be used in the manufacture of plant-based meat analogues.

### BRIEF DESCRIPTION

One aspect of the present disclosure is directed to an animal fat substitute composition comprising a stable emulsion comprising a mixture of one or more plant proteins, and a plant-based ingredient selected from the group consisting of a plant-based oil, a plant-based fat, and combinations thereof.

One aspect of the present disclosure is directed to an animal fat substitute composition comprising an emulsion comprising a mixture of one or more plant proteins, and a plant-based ingredient selected from the group consisting of a plant-based oil, a plant-based fat, and combinations thereof, wherein the mixture is stabilized with an effective amount of transglutaminase.

One aspect of the present disclosure is directed to an animal fat substitute composition comprising a stable emulsion comprising a mixture of one or more plant proteins, a plant-based ingredient selected from the group consisting of a plant-based oil, a plant-based fat, and combinations thereof, and water, wherein the composition comprises a protein to water ratio of from about 1:1 to about 1:10.

Another aspect of the present disclosure is directed to an animal fat substitute composition, wherein the mixture of the one or more plant proteins, and the plant-based ingredient selected from the group consisting of a plant-based oil, a plant-based fat and combinations thereof, is included in a continuous phase of the emulsion.

Another aspect of the present disclosure is directed to an animal fat substitute composition, wherein the one or more plant proteins contain lysine and glutamine amino acids.

Another aspect of the present disclosure is directed toward a process for preparing an animal fat substitute composition comprising forming a mixture comprising one or more plant proteins, a plant-based ingredient selected from the group consisting of a plant-based oil, a plant-based fat, and combinations thereof, and water; and emulsifying the mixture to form a stable emulsion.

Another aspect of the present disclosure is directed toward a process for preparing an animal fat substitute composition comprising forming a mixture comprising one or more plant proteins, a plant-based ingredient selected from the group consisting of a plant-based oil, a plant-based fat, and combinations thereof, and water; emulsifying the mixture to form an emulsion; and stabilizing the emulsion with an effective amount of transglutaminase.

### BRIEF DESCRIPTION OF THE DRAWINGS

FIG. 1 illustrates the structure of an animal fat tissue composed of adipocytes encased in a structured collagen matrix.

FIG. 2 illustrates a stabilized two-phase system of immiscible liquids.

FIG. 3 illustrates the crosslinking of lysine and glutamic acid with transglutaminase.

FIG. 4 illustrates the effect of protein dispersion index (PDI) content on the gel strength of the analyzed samples of Table 1.

FIG. 5 illustrates the appearance of an embodiment of the animal fat substitute composition after thermal processing

FIG. 6 illustrates the appearance of an embodiment of the animal fat substitute composition after processing.

FIG. 7 illustrates the appearance of analog fat tissues T27, T35 and T43 after cooking.

FIG. 8 illustrates the appearance of analog fat tissue T43 after extrusion.

FIG. 9 illustrates the appearance of analog fat tissue T43 after grinding.

FIG. 10 illustrates the appearance of analog fat tissue T43 after slicing.

FIGS. 11-13 illustrate embodiments of analog fat tissue products in final packaged forms.

### DETAILED DESCRIPTION

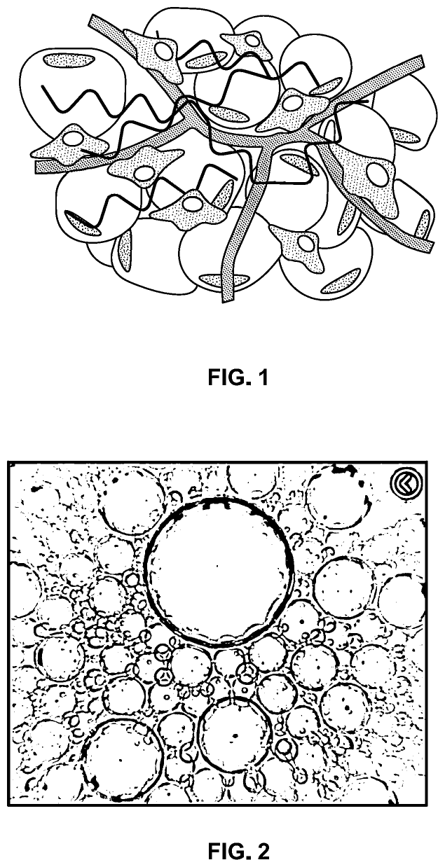

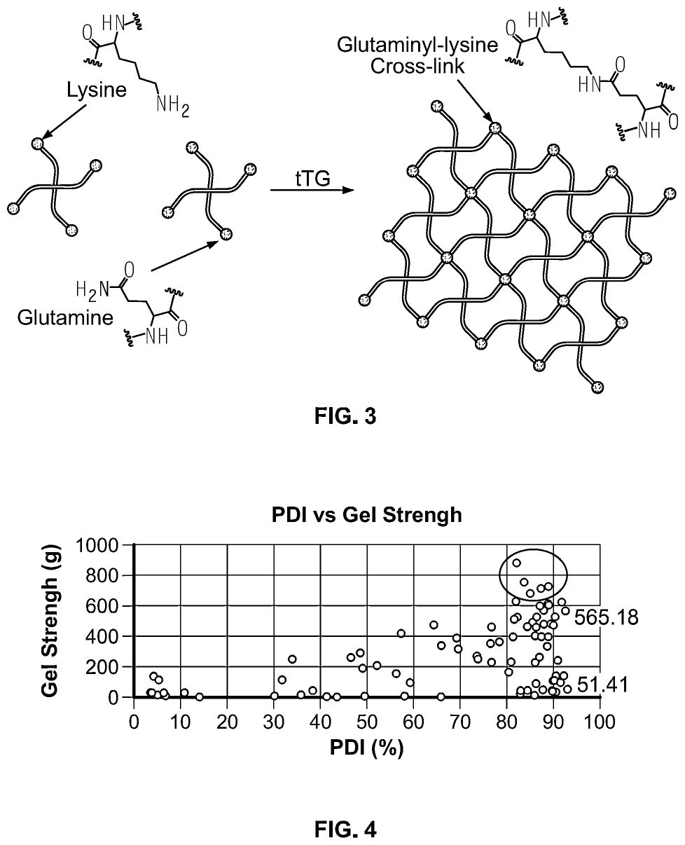

Animal fat is a complex tissue composed of adipocytes encased in a structured collagen matrix, as illustrated in FIG. 1. In some aspects, a less stable, but similar structure is present in food emulsions, which may include two-phase systems of immiscible liquids generally stabilized by the use of emulsifiers and other techniques, as illustrated in FIG. 2. In some aspects, one phase may be in the form of finely divided droplets of oil referred to as a discontinuous phase. The discontinuous phase may be suspended in a continuous or external phase. Most food emulsions are oil-in-water type emulsions, examples including mayonnaise and salad dressings. Emulsion properties generally depend on the nature of the continuous phase and the proportion of the continuous phase to the dispersed phase.

Other similar systems may include emulsion gels including matrices composed of denatured and/or crosslinked protein or carbohydrate networks containing emulsified lipids. The role of oil droplets within such crosslinked networks may depend on the size and number of droplets, the chemical and/or physical nature of the emulsion and interfacial membrane or component surrounding the emulsified oil droplets. In some aspects, liquid oil (room temperature) may be used for the production of either un-crosslinked or crosslinked oil-in-water emulsions and a certain amount of solid fat may be used to achieve animal fat characteristics. In various aspects, the functionality of plant proteins dispersed or dissolved in the external phase may affect the formation of protein emulsions.

The rheological properties of colloidal dispersions (i.e., emulsions) and gels are closely related to their disperse phase volume fraction. At relatively low ϕ (internal phase), the main forces driving droplet motion are Brownian forces. However hydrodynamic interactions and droplet-droplet collisions become increasingly important as the droplet concentration increases. In some aspects, at high volume fractions (e.g., greater than about 74% internal phase), the particles may adopt face-centered cubic characteristics, where they become closely packed, thereby leading to a solid-like behavior.

Transglutaminase (TG) is an enzyme that may be used to catalyze the acyl-transfer reaction between the γ-carboxyamide group of glutamine residues in peptide-bonds and primary amines. In various aspects, TG may be utilized to crosslink protein molecules. In some aspects, TG may be used to link glutamine and lysine amino acids contained in plant proteins to form crosslinked plant protein molecules. The crosslinks that may be formed between glutamine and lysine amino acids by reaction with TG are generally covalent bonds that are strong and stable, in contrast with weaker electrostatic and hydrophobic interactions within and across proteins. In some aspects, products stabilized with TG may be able to maintain their original texture, after retorting, for a longer time than other treatments under similar conditions.

The present disclosure relates to animal fat substitute compositions including an emulsion comprising a mixture of one or more plant proteins, and a plant-based ingredient that may be selected from plant-based oils, plant-based fats and combinations thereof, wherein the mixture may be stabilized with or without an effective amount of transglutaminase. In various aspects, the emulsion may be an oil-in-water emulsion. In various aspects, effective amounts of transglutaminase may be added to enhance the strength of the emulsion. In various aspects, effective amounts of transglutaminase may be added to stabilize the emulsion, when, for example, the emulsion does not have sufficient similarity with animal tissue in terms of structure and functionality.

In some aspects, the animal fat substitute composition of the disclosure comprises a mixture of the one or more plant proteins, and the plant-based ingredient that may be selected from plant-based oils, plant-based fats and combinations thereof, in the continuous phase of the emulsion, stabilized by reaction with transglutaminase. In some aspects, the animal fat substitute composition of the disclosure comprises a mixture of the one or more plant proteins, and the plant-based ingredient that may be selected from plant-based oils, plant-based fats and combinations thereof, in the continuous phase of the emulsion, stabilized without the use of transglutaminase.

In various aspects, suitable plant proteins may include any plant protein that may be effectively crosslinked using TG. In various aspects, suitable plant proteins may include any plant protein that can form, as part of a mixture with one or more oils and/or one or more fats, a stable animal fat substitute composition, without the use of TG. In various aspects, the degree of intermolecular and intramolecular crosslinking by TG may be related to the three-dimensional structure of the protein as well as the amount of lysine and glutamic acid contained in the protein. In some aspects, the hydrophilic and lipophilic balance of the protein may also influence the crosslinking effect of TG, as glutamic acid and lysine need to be free to form a network (see FIG. 3).

In various aspects, suitable plant proteins that may be effectively crosslinked using TG include pea protein, canola protein, soybean protein, yellow lentil protein, red lentil protein, fava bean protein, chickpea protein and mixtures thereof. In various aspects, suitable plant proteins that can form, as part of a mixture with one or more oils and/or one or more fats, a stable animal fat substitute composition, without the use of TG may include soybean protein. In various aspects, the plant proteins may be included in an amount from about 1% to about 20% by weight of the animal fat substitute composition. In some aspects, the plant proteins may be included in an amount of about 1%, 2%, 3%, 4%, 5%, 6%, 7%, 8%, 9%, 10%, 11%, 12%, 13%, 14%, 15%, 16%, 17%, 18%, 19% or 20% by weight of the animal fat substitute composition, or any range between any two of these amounts including from about 2% to about 15% by weight of the animal fat substitute composition, or from about 5% to about 15% by weight of the animal fat substitute composition.

In various aspects, suitable plant-based oils may include edible plant-based oils. Suitable edible plant-based oils include naturally occurring plant-based oils and/or synthetic plant-based oils. Suitable naturally occurring plant-based oils include various vegetable oils, such as canola oil, soybean oil, safflower oil, sunflower oil, and the like. In various aspects, the plant-based oils may be included in an amount from about 10% to about 80% by weight of the animal fat substitute composition. In some aspects, the plant-based oils may be included in an amount of about 10%, 20%, 30%, 40%, 50%, 60%, 70% or 80% by weight of the animal fat substitute composition or any range between any two of these amounts including from about 20% to 80% by weight of the animal fat substitute composition, or from about 30% to about 80% by weight of the animal fat substitute composition.

In various aspects, suitable plant-based fats may include soybean fat, cottonseed fat, corn fat, almond fat, peanut fat, sunflower fat, rapeseed fat, olive fat, palm fat, palm kernel fat, iripe fat, shea butter fat, coconut fat, cocoa butter, and the like. In various aspects, the plant-based fats may be included in an amount from about 10% to 80% by weight of the animal fat substitute composition. In some aspects, the plant-based fats may be included in an amount of about 10%, 20%, 30%, 40%, 50%, 60%, 70% or 80% by weight of the animal fat substitute composition, or any range between any two of these amounts including from about 20% to about 80% by weight of the animal fat substitute composition or from 30% to about 80% by weight of the animal fat substitute composition.

In various aspects, the animal fat substitute composition of the disclosure may contain any amount of TG that is effective in stabilizing the composition. In some aspects, the animal fat substitute composition may include from about 0% to about 3% by weight of TG. In some aspects, the animal fat substitute composition may include from about 0%, 0.25%, 0.5%, 0.75%, 1%, 1.25%, 1.5%, 1.75%, 2%, 2.25%, 2.5%, 2.75%, or 3% by weight of TG, or any range between any two of these amounts, including from about 0.25% to about 1% by weight of TG.

The content of lysine and glutamic acid, crosslinked using TG, and the ratio of glutamic acid to lysine as well as solubility (as Protein Dispersibility Index—PDI) and viscosity for selected proteins are shown below in Table 1.

TABLE 1
Solubility, viscosity, Lysine and glutamic acid content of selected proteins.

| | Product | | | | | | |
|---|---|---|---|---|---|---|---|
| | | | | Yellow | Red | Fava | |
| | Pea | Canola | Soybean | Lentil | Lentil | Bean | Chickpea |
| Lysine, g/100 | 6.9 | 6.5 | 6.0 | 5.9 | 5.7 | 5.3 | 4.1 |
| ingredient | | | | | | | |
| Glutamic acid, | 16.1 | 24.0 | 20.1 | 15.9 | 15.7 | 15.6 | 11.5 |
| g/100 | | | | | | | |
| ingredient | | | | | | | |
| PDI, % | 90.9 | 86.3 | 85.1 | 82.5 | 82.5 | 86.1 | 65.8 |
| Viscosity 10% | 82.4 | 25.3 | 165.0 | 48.7 | 30.8 | 52.7 | 22.3 |
| solution, cP | | | | | | | |

In the analyzed products in Table 1, the quantity of lysine appeared to be the limiting factor, followed by the PDI content and viscosity. Solubility, as measured by PDI, was shown to impact emulsion quality. The effect of PDI content on gel strength for the analyzed products is further shown in FIG. 4. The products in the highlighted region are soy protein isolates.

In various aspects, the animal fat substitute compositions may further include water. In various aspects, water may be included in an amount from about 10% to about 50% by weight of the animal fat substitute composition. In some aspects, water may be included in an amount of about 10%, 20%, 30%, 40%, or 50% by weight of the animal fat substitute composition, or any range between any two of these amounts, including from about 20% to about 50% by weight of the animal fat substitute composition. In some aspects, the animal fat substitute compositions may comprise a protein-to-water ratio of about 1:1 to about 1:10, or about 1:1, 1:2, 1:3, 1:4, 1:5, 1:6, 1:7, 1:8, 1:9 or 1:10, or any range between any two of these ratios, including from about 1:3 to about 1:6.

In various aspects, the animal fat substitute compositions may further include an additive. Suitable additives include alginate, carboxymethylcellulose (CMC), native or modified starch, and the like. In some aspects, additives may be included in an amount from about 0% to about 5% by weight of the animal fat substitute composition, or about 0%, 1%, 2%, 3%, 4% or 5% by weight of the animal fat substitute composition, or any range between any two of these amounts.

The present disclosure also relates to a process for preparing animal fat substitute compositions by mixing one or more plant proteins, and a plant-based ingredient that may be selected from plant-based oils, plant-based fats and combinations thereof, with water, and emulsifying the mixture to form a stable emulsion. In various aspects, the process comprises forming a stable emulsion with or without the use of an effective amount of transglutaminase. In some aspects, the process comprises stabilizing the emulsion with an effective amount of transglutaminase.

In various aspects, the process comprises adding effective amounts of transglutaminase to enhance the strength of the emulsion. In various aspects, the process comprises adding effective amounts of transglutaminase, when, for example, the emulsion does not have sufficient similarity with animal tissue in terms of structure and functionality. In some aspects, the process comprises forming a mixture wherein the one or more plant proteins, and the plant-based ingredient that may be selected from plant-based oils, plant-based fats and combinations thereof are present in the continuous phase of the emulsion, stabilized by a reaction with transglutaminase. In some aspects, the process comprises forming a mixture of the one or more plant proteins, and the plant-based ingredient that may be selected from plant-based oils, plant-based fats and combinations thereof, in the continuous phase of the emulsion, stabilized without the use of transglutaminase.

In various aspects, suitable plant proteins that may be included in the process include any plant protein that may be effectively crosslinked using TG. In various aspects, suitable plant proteins may include any plant protein that can form, as part of a mixture with one or more oils and/or one or more fats, a stable animal fat substitute composition, without the use of TG. In various aspects, suitable plant proteins that may be effectively crosslinked using TG include pea protein, canola protein, soybean protein, yellow lentil protein, red lentil protein, fava bean protein, chickpea protein and mixtures thereof. In various aspects, suitable plant proteins that can form, as part of a mixture with one or more oils and/or one or more fats, a stable animal fat substitute composition, without the use of TG may include soybean protein and mixtures thereof. In various aspects, the plant proteins may be included in an amount from about 1% to about 20% by weight of the animal fat substitute composition. In some aspects, the plant proteins may be included in an amount of about 1%, 2%, 3%, 4%, 5%, 6%, 7%, 8%, 9%, 10%, 11%, 12%, 13%, 14%, 15%, 16%, 17%, 18%, 19% or 20% by weight of the animal fat substitute composition, or any range between any two of these amounts including from about 2% to about 15% by weight of the animal fat substitute composition, or from about 5% to about 15% by weight of the animal fat substitute composition.

In various aspects, suitable plant-based oils that may be included in the process include edible plant-based oils. Suitable edible plant-based oils include naturally occurring plant-based oils and/or synthetic plant-based oils. Suitable naturally occurring plant-based oils include various vegetable oils, such as canola oil, soybean oil, safflower oil, sunflower oil, and the like. In various aspects, the plant-based oils may be included in an amount from about 10% to about 80% by weight of the animal fat substitute composition. In some aspects, the plant-based oils may be included in an amount of about 10%, 20%, 30%, 40%, 50%, 60%, 70% or 80% by weight of the animal fat substitute composition or any range between any two of these amounts including from about 20% to about 80% by weight of the animal fat substitute composition, or from 30% to about 80% by weight of the animal fat substitute composition.

In various aspects, suitable plant-based fats that may be included in the process include soybean fat, cottonseed fat, corn fat, almond fat, peanut fat, sunflower fat, rapeseed fat, olive fat, palm fat, palm kernel fat, iripe fat, shea butter fat, coconut fat, cocoa butter, and the like. In various aspects, the plant-based fats may be included in an amount from about 10% to 80% by weight of the animal fat substitute composition. In some aspects, the plant-based fats may be included in an amount of about 10%, 20%, 30%, 40%, 50%, 60%, 70% or 80% by weight of the animal fat substitute composition, or any range between any two of these amounts including from about 20% to 80% by weight of the animal fat substitute composition or from 30% to about 80% by weight of the animal fat substitute composition.

In various aspects, the process may include forming a stable emulsion by adding any amount of TG that is effective in stabilizing the animal fat substitute composition. In some aspects, the process may include adding an amount of TG from about 0% to about 3% by weight of the animal fat substitute composition In some aspects, the process may include adding an amount of TG of about 0%, 0.25%, 0.5%, 0.75%, 1%, 1.25%, 1.5%, 1.75%, 2%, 2.25%, 2.5%, 2.75%, or 3% by weight of TG, or any range between any two of these amounts, including from about 0.25% to about 1% by weight of the animal fat substitute composition.

In various aspects, the process of the disclosure may comprise forming a mixture of the one or more plant proteins, and the plant-based ingredient that may be selected from plant-based oils, plant-based fats, and combinations thereof, with an amount of water that represents about 10% to about 50% by weight of the animal fat substitute composition. In some aspects, water may be included in an amount of about 10%, 20%, 30%, 40%, or 50% by weight of the animal fat substitute composition, or any range between any two of these amounts, including from about 20% to about 50% by weight of the animal fat substitute composition. In some aspects, the process may comprise forming a mixture of the one or more plant proteins, the plant-based ingredient that may be selected from plant-based oils, plant-based fats, and combinations thereof, and water, wherein the mixture comprises a protein-to-water ratio of about 1:1 to about 1:10, or about 1:1, 1:2, 1:3, 1:4, 1:5, 1:6, 1:7, 1:8, 1:9 or 1:10, or any range between any two of these ratios, including from about 1:3 to about 1:6.

In various aspects, the process may further include adding an additive to the animal fat substitute composition. Suitable additives include alginate, carboxymethylcellulose (CMC), native and modified starches, and the like. In some aspects, additives may be included in an amount from about 0% to about 5% by weight of the animal fat substitute composition, or about 0%, 1%, 2%, 3%, 4% or 5% by weight of the animal fat substitute composition, or any range between any two of these amounts.

In various aspects, the process of the disclosure may comprise packaging the stable emulsion in a casing. Suitable casings may include any casing material effective in enclosing the emulsion therein. In some aspects, suitable casings include natural casings such as animal intestines, skin, or the like, or artificial casings such as fibrous, cellulose, plastic or collagen casings, and the like.

In various aspects, the animal fat substitute compositions of the disclosure may be used to address lifestyle concerns by providing options for replacement of meat proteins and meat fats by being included in plant-based alternative products. In some aspects, suitable plant-based alternative products include plant-based vegan products, plant-based bacon, plant-based burger, plant-based sausage, plant-based cold cuts, and plant-based fish. With the elimination of animal fats and animal protein, food products with a plant-based protein emulsion stabilized with and without transglutaminase, as described herein, can provide a vegan alternative for a healthy benefit.

In various aspects, the animal fat substitute composition may be included in the plant-based alternative product in an amount of from about 1% to about 80% by weight of the plant-based alternative product. In some aspects the animal fat substitute composition may be included in an amount of about 1%, 5%, 10%, 15%, 20%, 25%, 30%, 35%, 40%, 45%, 50%, 55%, 60%, 65%, 70%, 75% or 80% by weight of the plant-based alternative product, or any range between any two of these amounts, including from about 1% to about 65%, or about 5% to about 55% by weight of the plant-based alternative product.

### EXAMPLES

### Example 1

Exemplary formulations T1-T9 are presented below in Table 2.

TABLE 2

| | Test ID | | | | | | | | |
|---|---|---|---|---|---|---|---|---|---|
| | T1 | T2 | T3 | T4 | T5 | T6 | T7 | T8 | T9 |
| | Content, | Content, | Content, | Content, | Content, | Content, | Content, | Content, | Content, |
| Ingredient | % | % | % | % | % | % | % | % | % |
| PurePro 90E | 11.0 | 6.2 | 11.0 | 11.0 | 6.2 | 6.2 | | 7.75 | |
| Puratein C | | | | | | | 6.2 | | 6.2 |
| Water | 43.5 | 24.8 | 43.5 | 43.5 | 24.8 | 24.8 | 24.8 | 23.25 | 24.8 |
| Transglutaminase, | | | 1.0 | 1.0 | | 1.0 | 1.0 | | |
| TG-I | | | | | | | | | |
| NaCl | | | | 1.0 | | | | | |
| NH108 (palm fat) | 43.5 | 67.0 | 43.5 | 43.5 | 25.6 | 25.6 | 25.6 | 25.6 | 25.6 |
| Canola oil | | | | | 41.4 | 41.4 | 41.4 | 41.4 | 41.4 |
| 36DE Corn Syrup | 2.0 | 2.0 | 1.0 | 0.0 | 2.0 | 1.0 | 1.0 | 2.0 | 2.0 |
| Total | 100.0 | 100.0 | 100.0 | 100.0 | 100.0 | 100.0 | 100.0 | 100.0 | 100.0 |
| Ratio water-to- | 4.0 | 4.0 | 4.0 | 4.0 | 4.0 | 4.0 | 4.00 | 3.00 | 4.00 |
| protein | | | | | | | | | |
| Ratio oil-to-protein | 4.0 | 10.8 | 4.0 | 4.0 | 10.8 | 10.8 | 10.8 | 8.6 | 10.8 |

The various formulations shown above in Table 2 were compared in view of various variables, as shown below in Table 3.

TABLE 3
Formulation Comparisons vs. Variables Tested

| Variable | Test | Vs Test |
|---|---|---|
| Effect of Fat Quantity | T1 | T2 |
| Effect Transglutaminase | T1 | T3 |
| Effect of Salt | T3 | T4 |
| Effect of Fat Type | T2 | T5 |
| Effect of Transglutaminase × Fat Quantity | T3 | T6 |
| Effect of Protein Type × Transglutaminase | T6 | T7 |
| Effect of Hydration | T7 | T8 |
| Effect of Protein Type | T9 | T5 |

### Materials and Methods

### Equipment

The equipment employed in the experiments conducted herein is listed below:
UMC5 mixer for forming emulsions from Stephan GMBH having a 300 to 3000 rpm variable controlled motor that permits a specific rpm set (10 to 100%);
Busch vacuum pump, model RB 00056 C IZO, aiming to reduce the amount of air entrapped in the mixture during emulsification;
Combi Oven, Electrolux Air-o-steam touchline model oven, to perform the heat treatment of the preparations;
Stable Micro Systems (SMS) texture analyzer, model TA-XT2 to perform texture analysis;
Kitchen aid Plastic spatulas, 12 inch size to fill metal cans;
ULINE metal can, 5 cm height, 8 cm diameter with lid, 8 oz volume, Job #9685, to standardize methodology.

### Ingredients and Reagents

Ingredients/chemicals employed in the experiments are listed below:
Soybean Protein Isolate Bunge Purepro 90E, Batch #2020727, expiration date Jan. 26, 2022, minimum of 90% protein, maximum of 6% moisture with bland/neutral odor and color and viscosity @10% solids, 25° C., between 100 to 200 cp;
Canola Protein Isolate Merit Puratein C, Lot #142H2720AC500, best before Aug. 26, 2022, with minimum of 90% protein, maximum of 7% moisture, with yellow greenish color and characteristic canola flavor, and viscosity @10% solids, 25° C., below 50 cp;
Pea Protein Isolate Merit Peazazz, Lot #P1021AL08, best before Apr. 4, 2023, with minimum of 90% protein, maximum of 7% moisture, with pale yellow color and bland pea flavor, and viscosity @10% solids, 25° C., below 100 cp;
Soy Protein Concentrate Bunge PurePro 70E, Lot #20210126, best before Jan. 26, 2022, with minimum of 69% protein, maximum of 10% moisture, with bland/neutral odor and color and viscosity @10% solids, 25° C., between 600 to 10000 cp;
Soybean Protein Isolate Bunge Purepro 90EY, Batch D1052, expiration date of October 2022, minimum of 90% protein, maximum of 6% moisture with bland/neutral odor and color and viscosity @10% solids, 25° C., between 100 to 500 cp;
Bunge Old World Canola oil, Batch 0345714005 Lot L0074, oil stability index @110° C. of minimum of 7.5 hours, maximum 1 of red color, and a cold test of minimum of 12 hours was employed. Other technical characteristics of product are 0.05% maximum of Free Fatty Acids and peroxide value of 1.0 milliequivalent of 02 per kg;
Bunge Soybean Salad oil, Lot #H1181, Batch 1234714049, oil stability index @110° C. of minimum of 6 hours, maximum 1 of red color, and a cold test of minimum of 5.5 hours was employed. Other technical characteristics of product are 0.05% maximum of Free Fatty Acids and peroxide value of 1.0 milliequivalent of 02 per kg;
Bunge NH108 Palm based multipurpose fat, Batch 0168714057 Lot F0110, with no more than 3.5 red color, a drop point between 98-108° F., a Free Fatty Acid of maximum 0.05% and a maximum peroxide value of 1 milliequivalent of O₂ per kg. The Solid fat content was between 48-57% @10° C., 23-30% @20° C., 6-13% @30° C. and maximum of 5% solids @40° C.;
JRS Vivapur FD 176 Alginate, Batch4504002293, best before 17/11/2021, with viscosity 1% solution, 20° C., in Brookfield LVT 60 RPM, spindle 3 between 550-750 mPa·s, pH value in 1% solution between 5 to 8, maximum of 15% loss on drying, particle coarser than 100 microns of less than 5%;
Cargill A16M methylcellulose;
Cargill Fine prepared flour salt, Lot L0010777931 IHCZ;
ISI refined Kappa Carrageenan WG-2000, with a gel strength at 1.5% concentration of 800 g/cm2, with 95% particles passing through 80 mesh sieve, maximum 12% moisture and a pH range between 8 to 11;
Gateway Dextrose Corn Syrup, Dextrose equivalent DE 42/43 Lot 2018110;
Anjinomoto Activa TI100 Transglutaminase, Batch051119A, with pH action between 2 and 11 with optimal between 4 to 8, temperature of reaction between 0 to 80° C., with ideal in 50° C.;
Soybean Lecithin BungeMaxx 1200 Transparent and Clear soybean lecithin, with minimum of 62% acetone insoluble, acid value of maximum of 30 mg KOH/g, hexane insoluble of 0.05 maximum, moisture of maximum 1% and peroxide values of no more than 10 milliequivalent g of O₂/kg. Other characteristics include a maximum of 14 Gardner color and a viscosity at 10% solids, at 25° C. of 10000 cPs maximum.
Great Value Corn Starch, Lot code 21336, best if used by Dec. 2, 2023.

Fat Tissue Substitute Production Procedure Analog fat tissues were prepared using the following procedure:

Protein and water quantities are added in the UMC5 mixer bowl. The lid is closed and vacuum pump turned on at less than 0.8 bar. The UMC5 mixer is turned on at 1500 rpm for 1 minute. Vacuum is then broken and the lid opened. The surface of the lid is scraped to ensure all protein is in contact with water. The lid is closed again and mixer is turned on at 1500 rpm for 4 minutes under vacuum. Vacuum is broken and the lid opened. Salt and fat are added. The lid is closed and the mixer turned on at 1500 rpm for 1 minute under vacuum. Vacuum is broken and the lid opened to ensure materials are not stuck on the bowl side. The lid is closed and mixer turned on at 3000 rpm for 4 minutes under vacuum. Vacuum is broken and the lid opened. Transglutaminase is added. The lid is closed and mixer turned on at 3000 rpm for 1 minute under vacuum. Vacuum is broken and the lid opened.

The resulting material is added to metal cans with a spatula to avoid entrapping air. The filled metal cans are transferred to an oven and steam cooked at 155° F. for 20 minutes. The temperature is raised to 165° F. and the filled metal cans are cooked for an additional 20 minutes. The temperature is then raised to 175° F. for another 20 minutes. The temperature is then further raised to 185° F. and the filled metal cans are cooked to an internal temperature of 175° F. The filled metal cans are quenched in tap water and ice in a sink overnight. The cooked materials are removed and cooled to ambient temperature.

### Analytical Instruments for Gel Strength Determinations

Texture of the resulting samples was measured by compression of the samples using a Texture Analyzer (TXT2 plus “Stable Micro Systems”), equipped with a load cell of 5 kN, controlled with specific software (Texture Expert Exceed 2.52, Stable Micro Systems, Surrey, England). Samples were subjected to a 30 mm compression experiment, in which a 10-mm cylindrical probe was used for pressing downward into the cylinder container at 10 mm/s. Textural parameters of gel strength were defined as the maximum force of the probe in the course of penetration (maximum force required to compress the sample, in grams).

### Results

The gel strength force of each sample was analyzed. The results of the gel strength analysis are summarized in Table 4 below.

TABLE 4
Summary of results of gel strength determination for fat tissue analog samples

| | | | Emulsion | Emulsion | |
|---|---|---|---|---|---|
| | | | strength | strength | |
| | | | (g) | (g) | |
| | | | average | average | |
| Effect | Test | Test | for Test | for Test | Comments * |
| Effect of Fat Quantity @1:4 | T1 | T2 | 635.7 | 765.7 | Not statistically |
| protein-to-water ratio (43.5% vs | | | | | different |
| 67% fat) | | | | | |
| Effect of Transglutaminase | T1 | T3 | 635.7 | 926.5 | Statistically different |
| (without vs with) @1:4 | | | | | |
| protein-to-water ratio | | | | | |
| Effect of Salt (without vs with) @ | T3 | T4 | 926.5 | 1012.9 | Statistically different |
| 1:4 protein-to-water ratio | | | | | |
| Effect of Fat Type (Palm vs Palm | T2 | T5 | 765.7 | N.A | Broken emulsion- |
| and canola mixture) | | | | | T5 |
| Effect of Transglutaminase × fat | T3 | T6 | 926.5 | 1011.9 | Not statistically |
| quantity @ 1:4 protein-to-water | | | | | different |
| ratio (43.5% vs 67%) | | | | | |
| Effect of Protein type with | T6 | T7 | 1011.9 | 661.5 | Statistically different |
| Transglutaminase @1:4 | | | | | |
| protein-to-water ratio | | | | | |
| (Soy vs Canola) | | | | | |
| Effect of Hydration (1:4 vs 1:3 | T6 | T8 | 1011.9 | 832 | Statistically different |
| water-to-protein ratio) | | | | | |
| Effect of Protein Type (Canola vs | T9 | T5 | 389.4 | N.A | Broken emulsion - |
| Soy) @ 1:4 protein-to-water ratio | | | | | T5 |

* t student test, 95% confidence

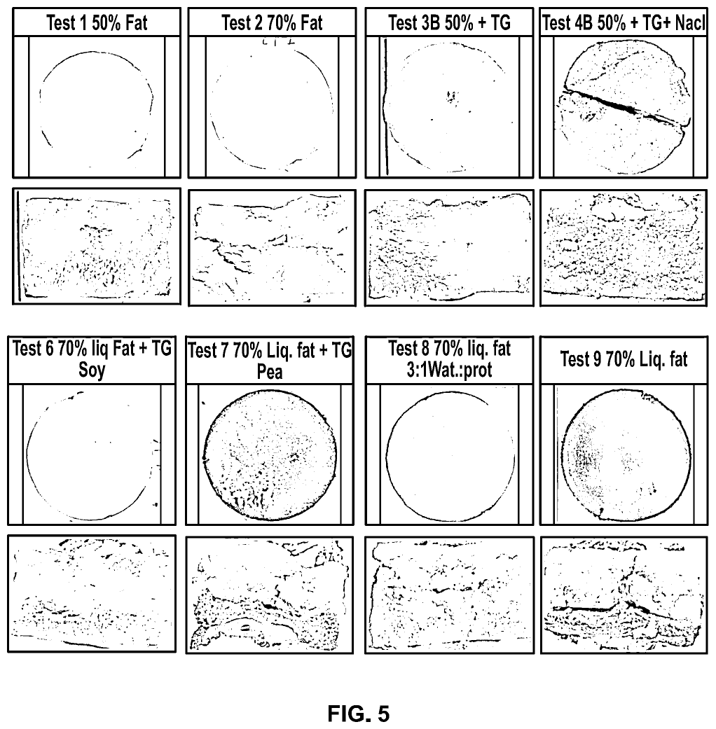

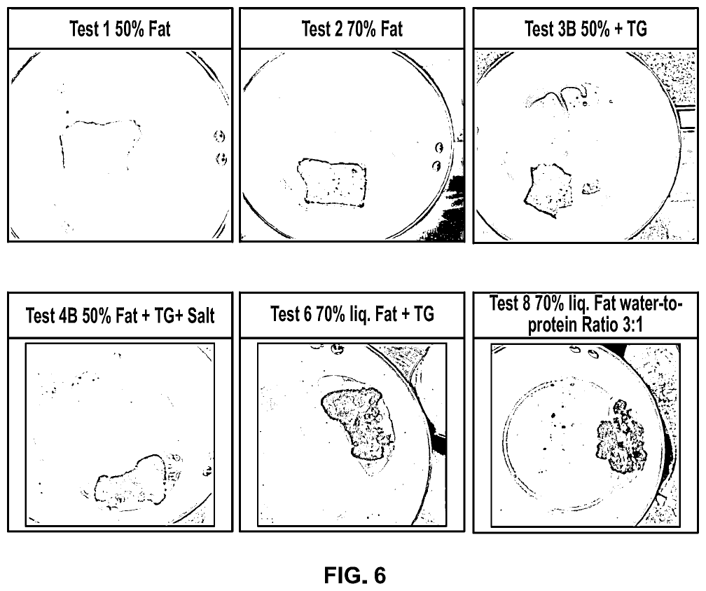

The greater the emulsion strength, the more resistance the product offers. It was observed that gel strength was not affected by the fat quantity (50% vs. 70%) and that transglutaminase appeared to work independently of this condition (no surface adsorption). Tests of formulations T1, T2, T3 and T6 appeared to produce a transparent wobbling fat under frying conditions. Illustrations of the fat tissue analog samples after cooking are shown in FIGS. 5 and 6.

### Example 2

The following formulations, shown in Table 5, were tested according to the experimental parameters previously described:

TABLE 5

| | | T10 | T11 | | | |
|---|---|---|---|---|---|---|
| | | increased | increased | T12 | T13 | |
| | T6 | water-to- | water-to- | T10 | T10 | T15 |
| | Base | protein | protein | with | without | T6 with |
| Ingredient | formulation | ratio | ratio | liquid | TG | Pea |
| PurePro 90E (wt %) | 6.2 | 5.2 | 4.4 | 5.2 | 5.2 | |
| Peazazz (wt %) | | | | | | 6.2 |
| Water (wt %) | 24.8 | 25.8 | 26.6 | 25.8 | 25.8 | 24.8 |
| Transglutaminase, | 1.0 | 1.0 | 1.0 | 1.0 | | 1.0 |
| TG-I (wt %) | | | | | | |
| NaCl (wt %) | | | | | | |
| Palm fat (wt %) | 67.0 | 67.0 | 67.0 | 25.6 | 67.0 | 67.0 |
| Soybean oil (wt %) | | | | 41.4 | | |
| Dextrose 42DE (wt %) | 1.0 | 1.0 | 1.0 | 1.0 | 2.0 | 1.0 |
| Total | 100.0 | 100.0 | 100 | 100 | 100 | 100 |
| Ratio water-to-protein | 4.0 | 5.0 | 6.0 | 5.0 | 5.0 | 4.0 |
| Ratio oil-to-protein | 10.8 | 12.9 | 15.2 | 12.9 | 12.9 | 10.8 |

Samples with increased water-to-protein ratios (T10 and T11) were formulated to both optimize the ingredient dosage and adjust the viscosity to optimize mixing during emulsification. Samples with a liquid oil (T12 and T13) were tested to verify both the structural and emulsification capacity of said samples. Further samples formulated with different sources of protein (T6 and T15) were analyzed to assess the crosslinking ability of TG.

Formulations in Table 5 were compared between their pair as described below in Table 6:

TABLE 6
Formulation Comparisons vs. Variables Tested in Example 2.

| Effect | Test | Vs Test |
|---|---|---|
| Water to protein ratio (4:1) vs (5:1) | T6 | T10 |
| Water to protein ratio (5:1) vs (6:1) | T10 | T11 |
| Effect of fat type | T10 | T12 |
| Effect of reduced protein on TG | T10 | T13 |
| Effect protein source (soy vs pea) | T6 | T15 |

The formulations were evaluated by the gel strength method previously described with a summary of results described below in Table 7.

TABLE 7
Gel strength results for Example 2

| | | | Emulsion | Emulsion | |
|---|---|---|---|---|---|
| | | Vs | strength | strength (g) | |
| Effect | Test | Test | (g) mean | mean | Comments |
| Water to | T6 | T10 | 1011.9 | 796.5 | Not statistically different |
| protein ratio | | | | | |
| (4:1) vs | | | | | |
| (5:1) @67% | | | | | |
| fat phase | | | | | |
| Water to | T10 | T11 | 796.5 | 645.9 | Statistically different |
| protein ratio | | | | | |
| (5:1) vs | | | | | |
| (6:1) @67% | | | | | |
| fat phase | | | | | |
| Effect of fat | T10 | T12 | 796.5 | 89.5 | Statistically different |
| type (67% | | | | | |
| fat vs fat | | | | | |
| and oil | | | | | |
| mixture, @1:5 | | | | | |
| protein-to- | | | | | |
| water ratio | | | | | |
| Effect of | T10 | T13 | 796.5 | 511.1 | Statistically different |
| reduced | | | | | |
| protein on | | | | | |
| TG. 67% | | | | | |
| internal | | | | | |
| phase, 1:5 | | | | | |
| protein-to- | | | | | |
| water phase | | | | | |
| Effect | T6 | T15 | 1011.9 | 901.45 | Not statistically different |
| protein | | | | | |
| source (soy | | | | | |
| vs pea) 67% | | | | | |
| internal | | | | | |
| phase, @1:4 | | | | | |
| protein-to- | | | | | |
| water ratio | | | | | |

* t student test, 95% confidence

It can be demonstrated that, while the emulsion and product can be formed, when a higher ratio of water-to-protein is used, a softer gel is formed. It also may be noted that a sufficient amount of protein to TG performs well as can be seen from the influence of TG on the reduced protein emulsions. Soy protein performs similarly to pea protein, indicating that TG acts independently of the protein source.

One of the characteristics desired for an analog fat tissue is its behavior must be similar to animal fat tissue, exhibiting a contraction behavior under heating conditions while the product is cooked and the observation of it shrinking in size.

The formulations in Table 5 were submitted for comparison of shrinkage, the samples were treated as described below:
The material was removed from the can;
The samples were brought to room temperature and then sliced to form a 70.3 mm diameter disc with a % inch thickness;
A nonstick pan was preheated to a temperature sufficient to boil 100 g of water in 4 minutes;
Samples were cooked on the pan for 80 seconds and then flipped and cooked an additional 80 seconds to ensure even cooking;
Samples were removed from frying pan and laid on a paper towel until ambient temperature was reached;
Samples were then measured with a caliber for the shortest and widest dimensions to provide an average final diameter of the cooked material.

The samples were then compared to their initial dimensions in order to determine the linear and area shrinkage, with results shown in Table 8:

TABLE 8
Average shrinkage for formulations of Example 2

| | T10 | T11 | T12 | T13 | T14 | T15 | T16 |
|---|---|---|---|---|---|---|---|
| Initial diameter | 70.3 | 70.3 | 70.3 | 70.3 | 70.3 | 70.3 | 70.3 |
| (mm) | | | | | | | |
| Mean Final | 51.00 | 48.50 | 57.50 | 62.50 | 57.50 | 52.25 | 57.25 |
| diameter (mm) | | | | | | | |
| Average linear | 27.45 | 31.01 | 18.21 | 11.10 | 18.21 | 25.68 | 18.56 |
| shrinkage (%) | | | | | | | |
| Area shrinkage (%) | 47.37 | 52.40 | 33.10 | 20.96 | 33.10 | 44.76 | 33.68 |

The results show that all formulations shrink after the cooking/frying procedure, which represents a desirable effect. It can also be seen that a high protein content enables a bigger contraction.

### Example 3

The formulations T10-T23, listed in Table 9 below, were also tested:

TABLE 9

| | | | | | T22 | |
|---|---|---|---|---|---|---|
| | | | | | 5:1 | T23 |
| | T10 | | | | water-to- | 5:1 |
| | increased | T19 | | | protein | water-to- |
| | water-to- | T10 | T20 | T21 | ratio, | protein |
| | protein | with | T10 | T10 with | 50% fat + | ratio, |
| Ingredient | ratio | lecithin | duplicate | Alginate | TG | 50% fat |
| PurePro 90EY (wt) | 5.2 | 5.2 | 5.2 | 5.2 | 8 | 8 |
| Peazazz (wt %) | | | | | | |
| Lecithin (wt %) | | 1.0 | | | | |
| Water (wt %) | 25.8 | 25.8 | 25.8 | 24.8 | 40 | 40 |
| Transglutaminase, | 1.0 | 1.0 | 1.0 | 1.0 | 1.0 | |
| TG -I (wt %) | | | | | | |
| Palm (wt) | 67.0 | 67.0 | 67.0 | 67.0 | 50.0 | 50 |
| Alginate (wt) | | | | 1.0 | | |
| Maltodextan (wt) | 1.0 | | 1.0 | | 1.0 | 2.0 |
| Total (wt %) | 100.0 | 100 | 100 | 100 | 100 | 100 |
| Ratio water-to- | 5.0 | 5.0 | 5.0 | 5.0 | 5.0 | 5.0 |
| protein | | | | | | |
| Ratio oil-to-protein | 12.9 | 12.9 | 12.9 | 12.9 | 6.3 | 6.3 |

Samples formulated with lecithin (T19) and alginate (T21) were tested to evaluate their effect on strength and ability to keep the fat in the formulations at a high fat content (67%). Some experiments with lower fat content were also tested to check the possibility of removing TG without compromising the gel characteristics. All formulations were formulated without salt to improve the final gel strength and simplify the process. The results are shown below in Table 10.

TABLE 10
Comparison pairs for Example 3

| Effect | Test | Vs Test |
|---|---|---|
| Effect of increase 70 vs 50% internal phase, @5:1 | T20 | T22 |
| Water-to-protein ratio | | |
| Effect of lecithin addition, | T20 | T19 |
| 70% internal phase, @5:1 | | |
| Water-to-protein ratio | | |
| Effect of alginate addition, | T20 | T21 |
| 70% internal phase, @5:1 | | |
| Water-to-protein ratio | | |
| Effect of TG removal on reduced protein and fat | T22 | T23 |
| (50% fat, 5:1 protein) | | |

The samples were evaluated for emulsion strength and the results are shown in Table 11.

TABLE 11
Gel strength results for Example 3

| | | | Emulsion | Emulsion | |
|---|---|---|---|---|---|
| | | Vs | strength | strength | |
| Effect | Test | Test | (g) mean | (g) mean | Comments |
| (5:1) Water to | T20 | T22 | 986.6 | 779.7 | Statistically |
| protein ratio; | | | | | different |
| effect of fat increase | | | | | |
| (5:1) Water to | T20 | T19 | 986.6 | 417.7 | Statistically |
| protein ratio; | | | | | different |
| effect of lecithin | | | | | |
| (5:1) Water to | T20 | T21 | 986.6 | 1264.3 | Statistically |
| protein ratio; | | | | | different |
| effect of alginate | | | | | |
| Effect of TG removal on | T22 | T23 | 779.7 | 521.0 | Statistically |
| reduced protein and fat | | | | | different |
| (50% fat, 5:1 protein:water | | | | | |
| ratio) | | | | | |

* t student test, 95% confidence

Fat internal phase increase, lecithin addition and removal of TG from 50% fat formulations reduced gel strength. Alginate addition appeared to be a way to improve emulsion structure and add functionality to high shearing conditions of production, for example, as in sausage production.

The formulations in Table 9 were subject to body-of-proof and cooking procedures as in Example 2 and the results of the shrinkage are shown in Table 12 below:

TABLE 12
Average shrinkage for Example 3

| | T20 | T21 | T22 | T23 |
|---|---|---|---|---|
| Initial diameter (mm) | 70.3 | 70.3 | 70.3 | 70.3 |
| Mean Final diameter (mm) | 49.25 | 53.40 | 53.80 | 57.75 |
| Average linear shrinkage (%) | 29.94 | 24.04 | 23.47 | 17.85 |
| Area shrinkage (%) | 50.92 | 42.30 | 41.43 | 32.52 |

Due to the low emulsion strength in the added lecithin experiment (T19) the sample was discarded. The alginate (T21) sample produced firmer material and reduced the shrinkage compared to T20. Interestingly, the removal of TG reduced the amount of material contraction. These experiments demonstrated that there is a series of variables that can be tuned to achieve a desirable quantity of shrinkage.

### Example 4

Another characteristic important to analog fat tissue is its ability to resist freezing conditions, as would be expected in products that simulate animal cuts like bacon, salmon or pork chops.

To evaluate ability to resist freezing, samples were subjected to a freezing cycle at −18° C. for 48 hours followed by a room temperature thawing process. Samples were then evaluated for emulsion strength as previously described. Results are shown in Table 13.

TABLE 13
Emulsion strength after freeze-thawing.

| | Tissue Strength (g) | Tissue Strength (g) | Strength reduction |
|---|---|---|---|
| | After preparation | After freezing | (%) |
| T19 | 417.7 | NA* | NA* |
| T20 | 986.6 | 652.3 | 34 |
| T21 | 1264.3 | NA* | NA* |
| T22 | 779.7 | 549.4 | 30 |
| T23 | 521.0 | 426.1 | 18 |

*Not applicable—Not enough sample to analyze

The results demonstrated that the freezing process reduced the average strength of analog fat tissues. Freezing seemed to have a major impact, as initial tissue strength was higher.

### Example 5

The formulations described in Table 14 were also tested.

TABLE 14

| | | | | | T31 | | | | |
|---|---|---|---|---|---|---|---|---|---|
| | | T28 | | T30 | T27, | T32 | T33 | | |
| | | T27 | T29 | T27, | no | T27, | T27, | | |
| | | @3% | T27 | TG | TG | TG | TG | T34 | T35 |
| | | protein | no | 70% | 70% | 70% | 70% | Peazazz | Peazazz |
| Ingredient | T27 | of TG | TG | fat | fat | fat | fat | 50% | 70% |
| PurePro 70E | 8.3 | 8.3 | 8.3 | 5.2 | 5.2 | 5.2 | 5.2 | | |
| (wt %) | | | | | | | | | |
| PurePro 90E | | | | | | | | | |
| (wt %) | | | | | | | | | |
| Peazazz (wt %) | | | | | | | | 8.3 | 5.2 |
| Water (wt %) | 41.7 | 41.7 | 41.7 | 25.8 | 25.8 | 25.8 | 25.8 | 41.7 | 25.8 |
| Transglutaminase, | 1.0 | 0.25 | 0.0 | 1.0 | 0.0 | 1.0 | 1.0 | 1.0 | 1.0 |
| TG -I (wt %) | | | | | | | | | |
| Canola Oil (wt %) | 49.0 | 49.75 | 50.0 | 68.0 | 69.0 | 67.0 | 67.0 | 49.0 | 67.0 |
| Carrageenan | | | | | | 1.0 | | | |
| (wt %) | | | | | | | | | |
| CMC (wt %) | | | | | | | 1.0 | | |
| Total (wt %) | 100.0 | 100.0 | 100.0 | 100.0 | 100.0 | 100.0 | 100.0 | 100.0 | 99.0 |
| Ratio water-to- | 5.0 | 5.0 | 5.0 | 5.0 | 5.0 | 5.0 | 5.0 | 5.0 | 5.0 |
| protein | | | | | | | | | |
| Ratio oil-to- | 5.9 | 6.0 | 6.0 | 13.1 | 13.3 | 12.9 | 12.9 | 5.9 | 12.9 |
| protein | | | | | | | | | |

| | | | | T39 | T40 | | | |
|---|---|---|---|---|---|---|---|---|
| | T36 | T37 | T38 | T27, | T27, | T41 | T42 | T43 |
| | T27, | T27, | T27, | ISP | ISP | T27, | T27, | T27, |
| | TG | TG | TG | TG | TG | TG | TG | TG |
| | 70% | 70% | 70% | 70% | 70% | 50% | 50% | 60% |
| Ingredient | fat | fat | fat | fat | fat | fat | fat | fat |
| PurePro 70E | 5.2 | 5.2 | 5.2 | | | 8.3 | | 6.0 |
| (wt %) | | | | | | | | |
| PurePro 90EY | | | | 5.2 | 5.2 | | | |
| (wt %) | | | | | | | | |
| Peazazz (wt %) | | | | | | | 8.3 | |
| Water (wt %) | 25.8 | 25.8 | 25.8 | 25.8 | 25.8 | 41.7 | 41.7 | 33.0 |
| Transglutaminase, | 1.0 | 1.0 | 1.0 | 1.0 | 1.0 | 1.0 | 1.0 | 1.0 |
| TG -I (wt %) | | | | | | | | |
| Canola Oil (wt %) | 68.0 | 68.0 | 68.0 | 68.0 | 68.0 | 49.0 | 49.0 | 60.0 |
| Soybean Oil | | | | | | | | |
| (wt %) | | | | | | | | |
| Carrageenan | | | | | | | | |
| (wt %) | | | | | | | | |
| CMC (wt %) | | | | | | | | |
| Total (wt %) | 100.0 | 100.0 | 100.0 | 100.0 | 100.0 | 100.0 | 100.0 | 100.0 |
| Ratio water-to- | 5.0 | 5.0 | 5.0 | 5.0 | 5.0 | 5.0 | 5.0 | 5.5 |
| protein | | | | | | | | |
| Ratio oil-to- | 13.1 | 13.1 | 13.1 | 13.1 | 13.1 | 5.9 | 5.9 | 10.0 |
| protein | | | | | | | | |

Table 14 illustrates a series of different formulations with different objectives. Formulations T27 to T29 were formulated for TG optimization, with the objective of avoiding over-usage and ingredient declaration in the label. Formulations T30 and T31 aimed to increase the fat internal phase to 70%. Formulations T32 and T33 tested the effect of different hydrocolloids on the quality and strength of the emulsion. Formulations T34 and T35 tested pea protein as the protein structure source. Formulations T36 to T38 employed functional soy protein concentrate (SPC) in substitution of isolated soy protein (ISP) as the protein structure source. Formulations T39 and T40 employed repeat ISP conditions with 70% of oil in the internal phase. Finally, formulations T41 to T43 presented different conditions of production with the objective of increasing the oil internal phase.

Formulations T39 and T40 did not produce a stable enough emulsion. Isolated Soy Protein (ISP) was believed to have a high emulsification capacity, but the isolated soy protein employed demonstrated inferior performance in emulsifying oil compared to Functional Soy Protein Concentrate (FSPC) products.

Formulations T27 to T29 were compared to their fat counterparts (T22 and T23) for emulsion strength as shown in Table 15.

TABLE 15
Emulsion strength of T27, T28 and T29
compared to T22 and T23 in grams.

| | | | T22 - 50% Fat, TG, | T23 - 50% Fat, Soy |
|---|---|---|---|---|
| | | | Protein-to-water | Protein-to-water |
| | | | ratio | ratio |
| T27 | T28 | T29 | 5:1 | 5:1 |
| 557.14 | 719.74 | 450.14 | 779.7 | 521.0 |

The experiments in Table 15 changed the ISP (T22 and T23) to FSPC (T27, T28, and T29) and demonstrated that it is possible to incorporate 50% of oil as the internal phase and produce emulsions with similar strength to Fat and ISP counterparts. The characteristics of the gels, however, were very different with the fat-based formulations showing no flexibility and a plastic behavior, and the oil-based formulations exhibiting a very elastic behavior.

Formulations T30 to T33 showed that formulating 70% of the internal phase with ISP and oil produced no fruitful results. It was observed that the soy proteins employed had an emulsification rate that was lower than this limit.

The emulsion strength of formulations T34 and T35 were compared to their fat counterparts (T11) as shown in Table 16.

TABLE 16
Emulsion strength (in grams) of T34 and T35 compared to T11

| T34 | T35 | Test 11 70% Fat, Pea Protein ratio 4:1 |
|---|---|---|
| 263.01 | 530.75 | 901.45 |

Formulations T34 and T35, characterized by oil internal phases, were softer than the T11 sample, and were able to produce a stable and stand-up emulsion, with T35 providing a sliceable and elastic final sample.

Formulations T36 to T39, formulated with 70% of the internal phase having ISP instead of FSPC and oil produced no fruitful results. With the change in the source of protein, there was a limit of oil emulsification either in FSPC, that is probably closer to the formulation with ISP, which was between 50 and 70% of the internal phase for soy proteins.

Formulations T41 to T43 were compared to evaluate the effect of TG on analog fat tissue formation, and their emulsion strength results are listed below in Table 17.

TABLE 17
Emulsion strength results (in grams) of
T41, T42 and T43 with and without TG

| T41 | T42 no TG | T42 | T43 no TG | T43 |
|---|---|---|---|---|
| 580.00 | 581.19 | 927.28 | 734.75 | 771.54 |

T41 and T42 were duplicated, and their results showed a good repeatability of the process itself. The addition of TG increased the gel strength in both the T42 and T43 formulations, having a larger impact in the formulation with the lower internal phase content. All of the fat analog formulations produced in Examples 1-5, however, demonstrated enough firmness and behavior compared to animal tissue.

In addition to current bench methods, some formulations were selected to be scaled up to a pilot scale process. The formulations chosen to be scaled up were based on the best bench scale results and are listed below in Table 18.

TABLE 18

| | T27 | T35 | T43 |
|---|---|---|---|
| Ingredient | FSPC | Peazazz | FSPC |
| | 50% oil | 70% oil | 60% oil |
| PurePro 70E (wt %) | 8.3 | | 6.0 |
| Peazazz (wt %) | | 5.2 | |
| Water (wt %) | 42.25 | 26.55 | 34.0 |
| Transglutaminase (wt %) | 0.25 | 0.25 | 0.0 |
| Canola Oil (wt %) | 49.0 | 68.0 | 60.0 |
| Total (wt %) | 100.0 | 100.0 | 100.0 |
| Ratio water-to-protein | 5.0 | 5.0 | 5.5 |
| Ratio oil-to-protein | 5.9 | 12.9 | 10.0 |

15 K batches of these formulations were prepared in a Seydelmann model K64AL8Va bowl chopper.

The analog fat tissue formulations were prepared as follows:
An iced water solution (50% ice and 50% water) was prepared in an amount to provide enough water phase for the preparation;
The iced water was put in the bowl;
The chopper was turned on at a mixing speed of 900 rpm and protein was slowly added to the water. (about 1 minute for a 15 kg preparation);
A good dispersion of protein was ensured while verifying the absence of fisheyes;
The lid was closed and the vacuum was turned on until 100 mbar was reached;
The protein was mixed for an extra 3 minutes in this condition;
The vacuum was turned off and the lid of the equipment was opened;
Half of the oil was slowly added to the hydrated protein (2 min addition time for a 15 kg batch);
The lid was closed and the vacuum pump was turned on until 100 mbar was reached;
The speed was increased to 1200 rpm and the mixture was mixed for 1 min in this condition;
The vacuum was turned off, the lid was opened and the speed was reduced to 900 RPM;
The remaining oil in the formulation was slowly added (2 minutes for a 15 kg formulation);
The lid was closed and the vacuum was turned on to reach 100 mbar;
The mixture was mixed for an extra 2 minutes at 1200 rpm;
The vacuum was broken and the lid opened;
The transglutaminase was added to the formulation, the lid closed and the vacuum turned on to 100 mbar;
The speed was adjusted to 3000 rpm and the mixture was mixed for an extra 1 minute;
All of the product was removed from the bowl and accommodated in a stainless steel pan for the cooking procedure;
The product was cooked in a Combi Oven (100% moisture) by a stepped procedure starting at 155° F. for 20 min; then 165° F. for 20 min, then 175° F. for 20 min, then 185° F. for 20 min until a temperature of 70° C. was reached;
the product was removed from the Combi Oven and immediately covered with plastic film to avoid protein blooming on the surface.

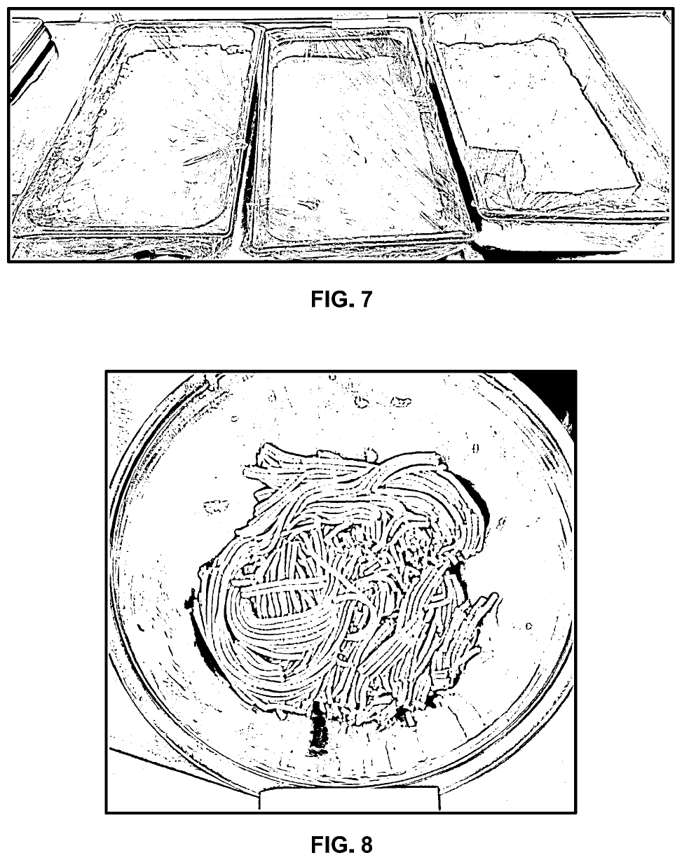

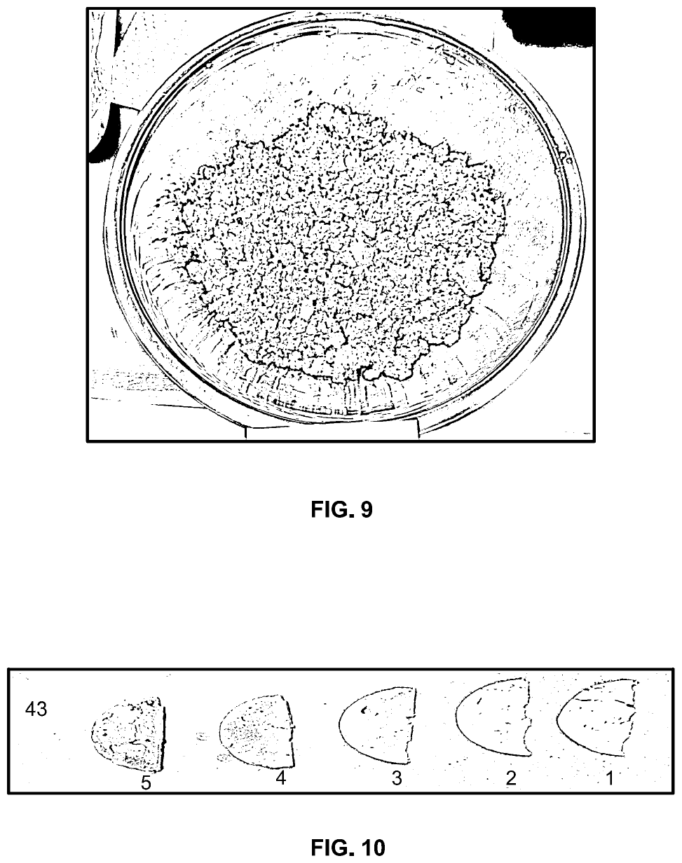

The fat tissue analogs produced were subjected to the cooking step previously described in Example 2 to ensure protein denaturation and TG inactivation. The analog fat tissues prepared in this way can be grinded, extruded and sliced in a series or form to provide a better suitability for this application. The formed gels and their machinability characteristics are illustrated in FIGS. 7-10.

In addition to pilot samples, the formulations were subject to packing tests to evaluate the ability of the formulation to be distributed over a series of final presentations. The formulation chosen was the T45 formulation described in Table 19.

TABLE 19

| | T45 |
|---|---|
| Ingredient | FSPC |
| | 50% oil |
| PurePro 70E (wt %) | 8.0 |
| Water (wt %) | 42.0 |
| Canola Oil (wt %) | 50.0 |
| Total (wt %) | 100.0 |
| Ratio water-to-protein | 5.5 |
| Ratio oil-to-protein | 10.0 |

15 kg batches of this formulation were prepared in a Seydelmann model K64AL8Va bowl chopper.

The analog fat tissue formulation was prepared as follows:
An iced water solution (50% ice and 50% water) was prepared in an amount to provide enough water phase for the preparation;
The iced water was put in the bowl;
The equipment was turned on at a mixing speed of 900 rpm and protein was slowly added to the water. (about 1 minute for a 15 kg preparation);
A good dispersion of protein was ensured while verifying the absence of fisheyes;
The lid was closed and the vacuum was turned on until 100 mbar was reached;
The protein was mixed for an extra 3 minutes in this condition;
The vacuum was turned off and the lid of the equipment was opened;
Half of the oil was slowly added to the hydrated protein (2 min addition time for a 15 kg batch);
The lid was closed and the vacuum pump was turned on until 100 mbar was reached;
The speed was increased to 1200 rpm and the mixture was mixed for 1 min in this condition;
The vacuum was turned off, the lid was opened and the speed was reduced to 900 rpm;
The remaining oil in the formulation was slowly added (2 minutes for a 15 kg formulation);
The lid was closed and the vacuum was turned on to reach 100 mbar;
The mixture was mixed for an extra 2 minutes at 1200 rpm;
The speed was adjusted to 3000 rpm and the mixture was mixed for an extra 1 minute.

At this point products were packed in three different ways:
1) transferred to a blue plastic bag made of food grade PP (Uline) with 6 gallon capacity. The bag was fitted in a 10×10×10 inch cardboard box and stored at 40° F.;
2) filled in a plastic casing composed of food grade PE (Viscoteepak model B1), through a Case machine (Ultrasource model PS-50) in 500 g size. 5 pieces were subjected to a cooking step in a Combi Oven (Alto Shaam, model CTP10-20E) (100% moisture) by a stepped procedure starting at 155° F. for 20 min; then 165° F. for 20 min, then 175° F. for 20 min, then 185° F. for 20 min, until a temperature of 70° C. was reached; and stored in a 40° F. refrigerator after cooking;
3) Filled in a fiber casing (Viscoteepak, model B1), through a Case machine (Ultrasource model PS-50) in 1 kg size. 3 pieces were cooked in a Combi Oven (Alto Shaam, model CTP10-20E) (100% moisture) by a stepped procedure starting at 155° F. for 20 min; then 165° F. for 20 min, then 175° F. for 20 min, then 185° F. for 20 min, until a temperature of 70° C. was reached; and stored in a refrigerator after cooking. Five pieces were cooked in a Combi Oven (Alto Shaam, model CTP10-20E) (100% moisture) by a stepped procedure starting at 155° F. for 20 min; then 165° F. for 20 min, then 175° F. for 20 min, then 185° F. for 20 min, until a temperature of 70° C. was reached and then stored at ambient temperature.

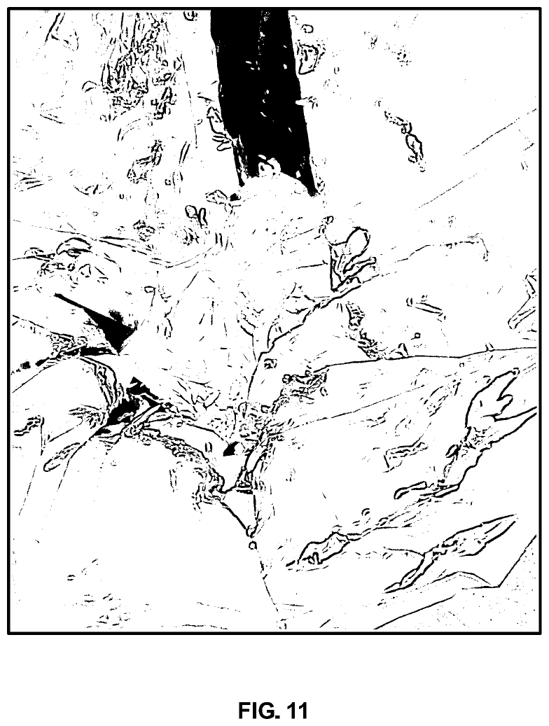

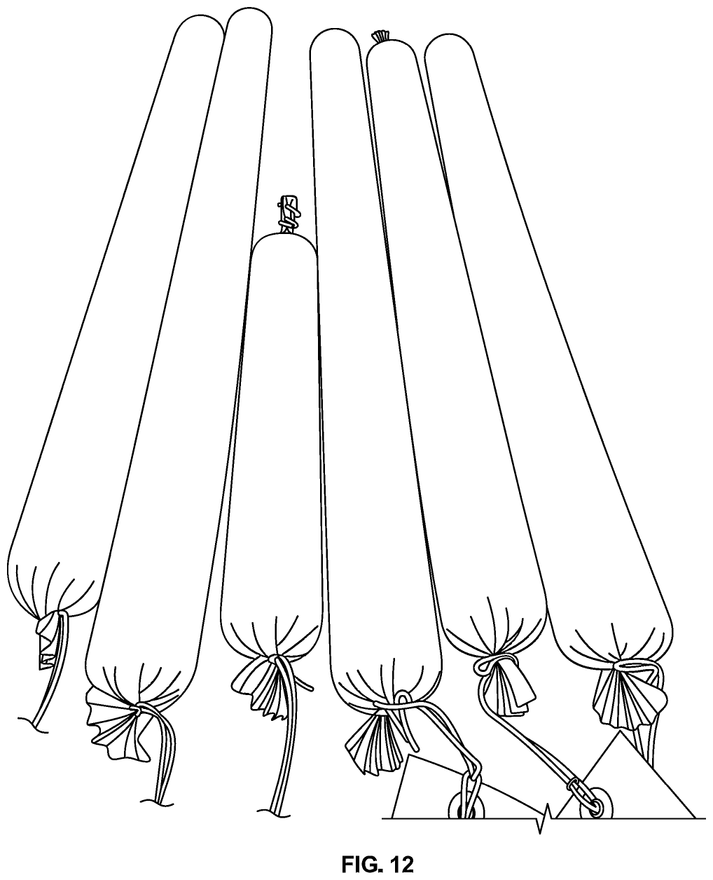

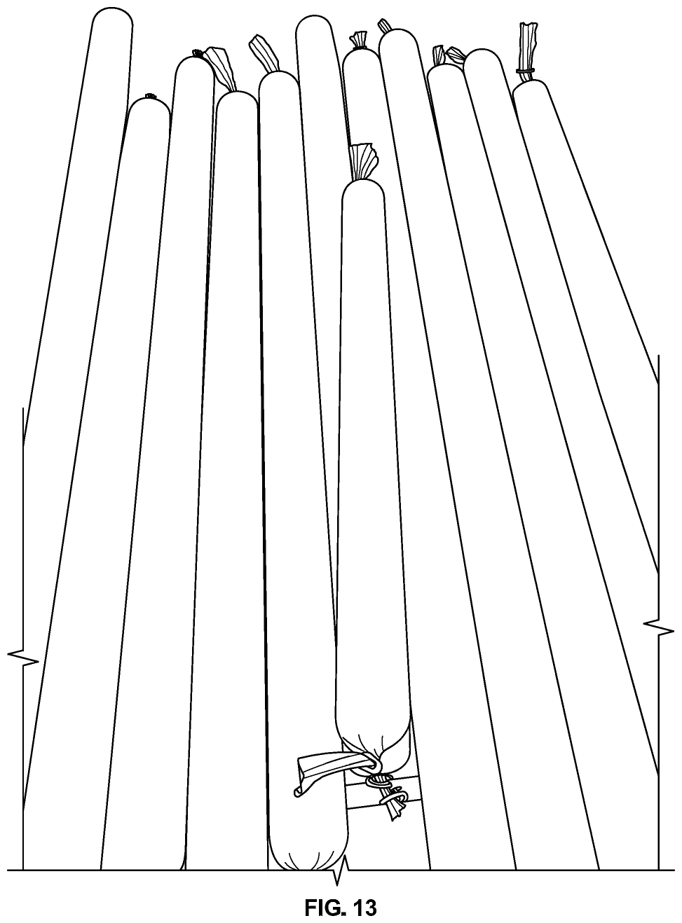

FIGS. 11, 12 and 13 demonstrate products in final forms and evidence that the product can be processed in different ways to fulfill application needs.

In addition to pilot samples, formulations were subject to a storage test to check the effect of temperature over quality of the proposed invention. The formulation chosen was the T45 formulation described in Table 20.

TABLE 20

| | T45 |
|---|---|
| Ingredient | FSPC |
| | 50% oil |
| PurePro 70E (wt %) | 8.0 |
| Water (wt %) | 42.0 |
| Canola Oil (wt %) | 50.0 |
| Total (wt %) | 100.0 |
| Ratio water-to-protein | 5.5 |
| Ratio oil-to-protein | 10.0 |

15 kg batches of these formulations were prepared in a Seydelmann model K64AL8Va bowl chopper.

The analog fat tissue formulations were prepared as follows:
An iced water solution (50% ice and 50% water) was prepared in an amount to provide enough water phase for the preparation;
The iced water was put in the bowl;
The equipment was turned on at a mixing speed of 900 rpm and protein was slowly added to the water. (about 1 minute for a 15 kg preparation);
A good dispersion of protein was ensured while verifying the absence of fisheyes;
The lid was closed and the vacuum was turned on until 100 bar was reached;
The protein was mixed for an extra 3 minutes in this condition;
The vacuum was turned off and the lid of the equipment was opened;
Half of the oil was slowly added to the hydrated protein (2 min addition time for a 15 kg batch);
The lid was closed and the vacuum pump was turned on until 100 mbar was reached;
The speed was increased to 1200 rpm and the mixture was mixed for 1 min in this condition;
The vacuum was turned off, the lid was opened and the speed was reduced to 900 rpm;
The remaining oil in the formulation was slowly added (2 minutes for a 15 kg formulation);
The lid was closed and the vacuum was turned onto reach 100 mbar;
The mixture was mixed for an extra 2 minutes at 1200 rpm;
The speed was adjusted to 3000 rpm and the mixture was mixed for an extra 1 minute.

At this point products were stored in three different ways.
1) transferred to a tin can, brand (ULINE model S23235 capacity) and stored at 40° F.;
2) transferred to a tin can, brand (ULINE model S23235 capacity) and cooked in a Combi Oven brand (Alto Shaam, model CTP10-20E) (100% moisture) by a stepped procedure starting at 155° F. for 20 min; then 165° F. for 20 min, then 175° F. for 20 min, then 185° F. for 20 min until a temperature of 70° C. was reached; and transferred and stored in a refrigerator at 40° F.;
3) transferred to a tin can, brand (ULINE model S23235 with 6 oz capacity) and cooked in a Combi Oven brand (Alto Shaam, model CTP10-20E) (100% moisture) by a stepped procedure starting at 155° F. for 20 min; then 165° F. for 20 min, then 175° F. for 20 min, then 185° F. for 20 min until a temperature of 70° C. was reached; and transferred and stored in a freezer at 0° F.

Table 21 demonstrates that cooked and non-cooked products behave similarly while freezing conditions could reduce some of the product characteristics.

TABLE 21

| Conditions | 1^{st} day | 3^{rd} day | 7^{th} day |
|---|---|---|---|
| Cooked hardness (in g) | 587 | 527 | 540 |
| Refrigerated hardness (in g) | 679 | 841 | 974 |
| Freeze hardness (in g) | 224 | 228 | 236 |

These results demonstrate the ability of the formulation to resist major storage conditions without losing its quality characteristics.

TABLE 21
Use of starch

| | T57 | T58 |
|---|---|---|
| PurePro 70E (wt %) | 8 | 8 |
| Corn Starch (wt %) | 3 | 5 |
| Water (wt %) | 41 | 40 |
| Canola Oil (wt %) | 48 | 47 |
| Total (wt %) | 100 | 100 |

The formulations, shown in Table 21, were tested according to the experimental parameters:

Protein, water, and starch are added in the UMC5 mixer bowl. The lid is closed and vacuum pump turned on at less than 0.8 bar. The UMC5 mixer is turned on at 1500 rpm for 1 minute. Vacuum is then broken and the lid opened. The surface of the lid is scraped to ensure all protein is in contact with water. The lid is closed again and mixer is turned on at 1500 rpm for 4 minutes under vacuum. Vacuum is broken and the lid opened. Salt and fat are added. The lid is closed and the mixer turned on at 1500 rpm for 1 minute under vacuum. Vacuum is broken and the lid opened to ensure materials are not stuck on the bowl side. The lid is closed and mixer turned on at 3000 rpm for 4 minutes under vacuum. Vacuum is broken and the lid opened. Transglutaminase is added. The lid is closed and mixer turned on at 3000 rpm for 1 minute under vacuum. Vacuum is broken and the lid opened.

The resulting material is added to metal cans with a spatula to avoid entrapping air. The filled metal cans are transferred to an oven and steam cooked at 155° F. for 20 minutes. The temperature is raised to 165° F. and the filled metal cans are cooked for an additional 20 minutes. The temperature is then raised to 175° F. for another 20 minutes. The temperature is then further raised to 185° F. and the filled metal cans are cooked to an internal temperature of 175° F. The filled metal cans are quenched in tap water and ice in a sink overnight. The cooked materials are removed and cooled to ambient temperature.

TABLE 22
Emulsion strength results (in grams) of T57 and T58 with starch.

| | | | Emulsion | Emulsion | |
|---|---|---|---|---|---|
| | | | strength | strength | |
| | | | (g) | (g) | |
| | | | average | average | |
| Effect | Test | Test | for Test | for Test | Comments * |
| Low level of starch (3%) vs no | T57 | T29 | 854.4 | 450.1 | Statistically different |
| Starch | | | | | |
| High level of starch (5%) vs. no | T58 | T29 | 678.1 | 450.1 | Statistically different |
| Starch | | | | | |

* t test, 95% confidence

The formulations with starch increased the emulsion strength compared to T29, representing an alternative when a harder particle is necessary for a hard sausage like pepperoni. Plant based or vegan products like bacon, burger, sausage, cold cuts, and fish benefit by the inclusion of an animal fat substitute composition comprising the stable emulsion of the disclosure. Rates of inclusion may be found in Table 23.

TABLE 23
Inclusion rates for the disclosed animal fat substitute composition.

| | Minimum | Maximum |
|---|---|---|
| Vegetable Product | (wt %) | (wt %) |
| bacon | 5 | 65 |
| burger | 1 | 20 |
| cold cuts | 5 | 50 |
| sausage | 5 | 50 |
| chicken | 1 | 40 |
| fish | 5 | 30 |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An animal fat substitute composition comprising:
a stable emulsion comprising a mixture comprising one or more plant proteins, and a plant-based ingredient selected from the group consisting of a plant-based oil, a plant-based fat, and combinations thereof.

2. The animal fat substitute composition of claim 1, wherein the mixture comprises one or more plant proteins and a plant-based oil or a plant-based fat.

3. (canceled)

4. (canceled)

5. The animal fat substitute composition of claim 1, wherein the one or more plant proteins are selected from the group consisting of soy protein, pea protein, canola protein, and combinations thereof.

6. The animal fat substitute composition of claim 1, wherein the composition further comprises water.

7. The animal fat substitute composition of claim 6, wherein the composition comprises a protein to water ratio of from about 1:1 to about 1:10.

8. The animal fat substitute composition of claim 6, wherein the composition comprises a protein to water ratio of from about 1:3 to about 1:6.

9. A process for preparing the animal fat substitute composition of claim 1, comprising
forming a mixture comprising one or more plant proteins, a plant-based ingredient selected from the group consisting of a plant-based oil, a plant-based fat, and combinations thereof, and water; and
emulsifying the mixture to form a stable emulsion.

10. The process of claim 9, further comprising packaging the stable emulsion in a casing.

11. (canceled)

12. The animal fat substitute composition of claim 1, wherein the emulsion is stabilized with an effective amount of transglutaminase.

13. (canceled)

14. (canceled)

15. (canceled)

16. The animal fat substitute composition of claim 12, wherein the mixture is contained in a continuous phase of the emulsion.

17. The animal fat substitute composition of claim 12, wherein the one or more plant proteins contain lysine and glutamine amino acids.

18. The animal fat substitute composition of claim 12, wherein the one or more plant proteins is selected from the group consisting of soy protein, pea protein, canola protein, and combinations thereof.

19. The animal fat substitute composition of claim 12, wherein the transglutaminase is present in the composition in an effective amount of about 0.25 to about 1% by weight of the composition.

20. (canceled)

21. (canceled)

22. (canceled)

23. The animal fat substitute composition of claim 12, wherein the composition further comprises additives selected from the group consisting of alginate, carboxymethylcellulose, native and modified starches, and combinations thereof.

24. (canceled)

25. The animal fat substitute composition of claim 12, wherein the plant-based oil or the plant-based fat is present in the composition in an amount from about 10% to about 80% by weight of the composition.

26. (canceled)

27. A process for preparing the animal fat substitute composition of claim 12, comprising
forming a mixture one or more plant proteins, a plant-based ingredient selected from the group consisting of a plant-based oil, a plant-based fat, and combinations thereof, and water;
emulsifying the mixture to form an emulsion; and
stabilizing the emulsion with an effective amount of transglutaminase.

28. The process of claim 27, further comprising packaging the stabilized emulsion in a casing.

29. (canceled)

30. (canceled)

31. (canceled)

32. (canceled)

33. (canceled)

34. (canceled)

35. The animal fat substitute composition of claim 2, wherein the plant-based oil or the plant-based fat is present in the composition in an amount from about 10% to about 80% by weight of the composition.

36. (canceled)

37. A food product comprising the animal fat substitute composition of claim 1.

38. The food product of claim 37, wherein the food product is selected from the group consisting of plant-based meat, plant-based bacon, plant-based burger, plant-based cold cut, plant-based sausage, plant-based chicken, plant-based fish, and combinations thereof.
